(19) United States
(12) Patent Application Publication
(10) Pub. No.: US 2018/0099265 A1
(43) Pub. Date: Apr. 12, 2018

(54) SYNGAS PRODUCTION FROM BINARY AND TERNARY CERIUM-BASED OXIDES

(71) Applicant: SABIC Global Technologies B.V., Bergen op Zoom (NL)

(72) Inventors: Hicham Idriss, Thuwal (SA); Yahya Al-Salik, Thuwal (SA)

(21) Appl. No.: 15/127,296

(22) PCT Filed: Jun. 10, 2015
(86) PCT No.: PCT/IB2015/054396

§ 371 Date: Sep. 19, 2016

Related U.S. Application Data
(60) Provisional application No. 62/011,916, filed on Jun. 13, 2014.

(51) Int. Cl. B01J 23/83; C01B 3/06; C01B 32/40; C01G 43/01; C01G 49/00; B01J 23/12; B01J 37/08; B01J 37/16; B01J 37/18

(52) U.S. Cl. CPC B01J 23/83; C01B 3/061; C01B 32/40; C01G 43/01; C01G 49/0054; C01P 2002/88; B01J 37/08; B01J 37/16; B01J 37/18; C01P 2002/72; C01P 2002/85; B01J 23/12

(57) ABSTRACT

Metal oxides having a lower activation temperature and enhanced oxygen mobility are disclosed. The metal oxides comprise oxygen (O), cerium (Ce) and one or both of iron (Fe) and uranium (U). Also disclosed are methods for producing hydrogen or carbon monoxide from water or carbon dioxide using the metal oxides.

### CROSS REFERENCE TO RELATED APPLICATIONS

This application claims benefit to U.S. Provisional Patent Application No. 62/011,916 titled “SYNGAS PRODUCTION FROM BINARY AND TERNARY CERIUM-BASED OXIDES” filed Jun. 13, 2014. The entire contents of the referenced application is incorporated herein by reference.

### BACKGROUND OF THE INVENTION

### A. Field of the Invention

The invention generally concerns metal oxides that can be used to produce carbon monoxide and hydrogen from carbon dioxide and water. The metal oxides include cerium and iron or uranium or both.

### B. Description of Related Art

Thermal hydrogen production from water using reducible materials is currently receiving considerable attention (See, A. T-Raissi et al., NASA/CR 2009, 215441; Xiao et al., Renewable Energy 2012,41:1-12; Kaneko et al., Solar Energy, 2011,85:2321-2330). The reaction can, in its simplified form, be presented as follows:

MₓO_{y}→xM+y/2O₂ (+ΔG) Equation 1

xM+yH₂O→O_{y}+yH₂ (−ΔG) Equation 2

where M is a metal cation and x and y are integers. These equations describe a thermo-chemical cycle whereby the metal oxide (MₓO_{y}) is first reduced by using heat. Subsequently, the reduced metal is exposed to water, thereby becoming oxidized again while also releasing hydrogen in the process. Additionally, the reduced metal product can be subjected to carbon dioxide, thereby producing carbon monoxide:

xM+y/2CO₂→MₓO_{y}+y/2CO (−ΔG) Equation 3

The first equation (which is endothermic) is the bottle neck of the process as the energy needed to remove oxygen anions from the metal oxide lattice is very high. To reduce this energy cost, many methods are currently under studies, including reacting metal oxide with hydrocarbons (Evdou et al., Hydrogen Energy 2008, 33:5554-5562), strong acids (Kodama & Gokon, Chem. Rev., 2007,107:4048-4077), or other bases (Perkins & Weimer, AlChE J. 2009,55:286-296). The second and third equations are exothermic and are more favorable from an energy input perspective.

While the above three equations can be used to produce hydrogen gas and carbon monoxide from water and carbon dioxide, respectively, the primary issue is the rate-limiting energy input step illustrated in equation 1. Further, the aforementioned attempts at solving this problem, i.e., reacting metal oxides with hydrocarbons, strong acids, and strong bases, have not offered a commercially viable solution.

### SUMMARY OF THE INVENTION

A solution to the aforementioned problem associated with the high energy input requirement illustrated in the above equation 1 has been discovered. The solution resides in the use of cerium-based metal oxides. In particular, and without wishing to be bound by theory, cerium dioxide has a fluorite lattice structure (See, FIG. 1) in which Ce⁴⁺ are eight-fold coordinated to O²⁻, and the later are four-fold coordinated to Ce⁴⁺ cations. In order to maintain stoichiometry, every other unit cell is empty of Ce⁴⁺. This structure, combined with the relatively weak Ce⁴⁺ to O²⁻ bond strength, allows for fast oxygen diffusion or ionic mobility when the cerium dioxide is subjected to a reducing reaction (e.g., Ce⁴⁺ to Ce³⁺). In the context of the present invention, it is believed that substituting a portion of the Ce⁴⁺ cations with either Fe or U cations, or both, allows for a further increase in O²⁻ removal and mobility. This substitution is also believed to further stabilize or maintain the fluorite structure during the reduction step. That is to say, the energy input required to release O²⁻ anions via the reduction of Ce⁴⁺ to Ce³⁺ is lowered without compromising the fluorite structure of the cerium oxide based material. Equation 1 above becomes a more favored reaction in the context of the present invention, which consequently allows for energy sources such as sunlight to drive the reactions to produce hydrogen gas from water or carbon monoxide from carbon dioxide.

In one aspect of the present invention there is disclosed a metal oxide material capable of producing hydrogen from water or carbon monoxide from carbon dioxide comprising oxygen (O), cerium (Ce), and one or both of iron (Fe) and uranium (U). The metal oxide can be a binary metal oxide (e.g., includes both Ce and Fe or Ce and U) or a ternary metal oxide (e.g., includes Ce, Fe, and Ce metals). In a particular embodiment, the metal oxide has a fluorite lattice structure, and the majority of Ce can be Ce (IV) prior to being reduced. The fluorite lattice structure can be preserved or remain stable when subjected to a temperature of 300 to 1400 K or more preferably from 900 to 1400 K. Also, the Fe can be Fe (III) or Fe (II) or a combination thereof prior to the material being subjected to a reducing reaction. Still further, the U can be U (IV), U (V), or U (VI), or a combination thereof prior to the material being subjected to a reduction or oxidation reactions. In some instances, the molar ratio of oxygen to metal in the metal oxide material can be equal to or less than 2.5. In a preferred embodiment, the metal oxide can have the following structure or stoichiometry: Ce_{w}FeₓU_{y}O_{z}, where 0<w<1, where 0.1≦x<(1−(w+y), where 0≦y<0.09, and where 1.5<z<2.5. In particular instances, z can be 1.5<z<2, or more preferably z can be 2. Non-limiting examples of ternary systems of the present invention include materials have the following stoichiometry: Ce_{0.5}U_{0.5}O₂, or Ce_{0.75}Fe_{0.25}O₂. In particular instances, the metal oxide can be reduced (e.g., via heat) and in contact with water or carbon dioxide or both water and carbon dioxide (e.g., a feed that includes water, a feed that include carbon dioxide, or a feed that includes both water and carbon dioxide). In certain instances, the metal oxide can be calcined metal oxide (e.g., calcination can be obtained by subjecting the metal oxide to a temperature of 400 to 600° C. for a sufficient amount of time to obtain calcination). The metal oxides of the present invention can be capable of producing hydrogen from water or carbon monoxide from carbon dioxide with solar radiation as an energy source. The metal oxide material can be comprised within a composition.

Also disclosed in the context of the present invention is a water-splitting system that includes any one of the metal oxides of the present invention. The water-splitting system can include a heat source, a water feed or a carbon dioxide feed or both, and a composition that includes any one of the metal oxides of the present invention. The heat source can be sunlight. In preferred embodiments, the sunlight can be concentrated sunlight (e.g. use of mirrors or lenses to concentrate a large area of sunlight, or solar thermal energy, onto a small area). The system can also include a collection device capable of storing produced H₂ or CO.

In another aspect of the present invention there is disclosed a method for producing hydrogen gas from water or carbon monoxide from carbon dioxide. The method can include the following steps: (i) reducing any one of the metal oxides of the present invention to form a reduced material; and (ii) contacting the reduced material with a feed that includes water or carbon dioxide or both under reaction conditions sufficient to produce hydrogen gas from the water and carbon monoxide from the carbon dioxide. These steps can be performed sequentially (e.g., (i) followed by (ii)) or simultaneously. In certain instances, the reaction takes place in a single step where step (i) is performed and then a feed that includes water or carbon dioxide or both is introduced while or immediately after step (ii) occurs. In particular instances, reducing the metal oxides of the present invention releases oxygen anions from the metal oxide thus creating the reduced material. The reduced material can then be contacted with water (preferably water vapor). The water can act as an oxidizing agent by oxidizing the reduced material via oxygen anions while also producing hydrogen gas. In this sense, it can be said that the water has been split into an oxygen anion and hydrogen gas. Similarly, the reduced material can be contacted with carbon dioxide (preferably in the gaseous phase). The carbon dioxide can act as an oxidizing agent by oxidizing the reduced material via oxygen anions while also producing carbon monoxide. In this sense, it can be said that the carbon dioxide has been split into an oxygen anion and carbon monoxide. The thus produced hydrogen gas and carbon monoxide can be stored and used in downstream chemical processes. By way of example, and in instances where both carbon monoxide and hydrogen gas are produced (e.g., from a feed that includes carbon dioxide and water or from multiple feeds, with one feed having carbon dioxide and another having water), synthesis gas or “syngas” is produced. The syngas can be used to produce a wide range of various products (See, FIG. 2), such as methanol synthesis, linear mixed alcohols, hydrogen, olefins, the so-called i-C₄ alcohols and hydrocarbons, Fischer-Tropsch products (e.g., waxes, diesel fuels, olefins, gasoline, etc.), ethanol, aldehydes, etc. Syngas can also be used as a direct fuel source, such as for internal combustible engines. In particular instances, steps (i) and (ii) can be performed at a temperature of 1200 to 1500° C. under an inert environment. However, other temperatures can be used (e.g., 300, 400, 500, 600, 700, 800, 900, 1000, 1100, 1200, 1300, 1400, 1500, 1600, 1700, 1800, 1900, or 2000° C., or more or any range therein can be used (e.g., 300 to 2000° C., 500 to 1500° C., etc.). In one non-limiting aspect, the following equation illustrations a method to reduce the oxide materials of the present invention by using hydrocarbons (e.g., methane):

Ce(U)O₂+xCH₄→Ce(U)O₂₋ₓ+xCO+2H₂.

In one instance, the metal oxides of the present invention can be reduced in the presence of H₂ at a temperature of at least 500° C. or between 500 to 1500° C. In another instance, the metal oxides of the present invention can be reduced in an inert environment at a temperature of 1000 to 2000° C. or 1000 to 1500° C. or at least about 1300° C. The inert environment can include an inert gas (e.g., N₂, He, or Ar, or any combination thereof). In some aspects, the carbon dioxide feed can be obtained from a power plant or other source that produces carbon dioxide. In one non-limiting aspect, the following reaction conditions can be used. The oxide material can be reduced under nitrogen environment at 1200-1500° C. (preferably 1400 to 1500° C.) with a flow rate of about 80 to 100 mL/min. g_{oxide} (preferably about 100 mL/min. g_{oxide}) initially for at least 60 minutes or more to complete the reaction. This can be followed by lowering the temperature to less than 1200° C. (preferably about 1000° C.) and introduce steam at a vol % of about 3 to 7% (preferably about 5%) in nitrogen at a similar flow rate. Hydrogen production can then be monitored using a gas chromatograph for quantitative analysis. Once all hydrogen has been produced (about 5 to 15 minutes or preferably about 10 minutes) the oxide can then be heated again to 1200-1500° C. (preferably 1400 to 1500° C.) under N₂ for the reduction step and the cycle can be repeated. Similar reaction conductions are conducted for CO₂ (instead of water).

In yet another aspect of the present invention there is disclosed a method for making any one of the metal oxides of the present invention. The method can include mixing cerium nitrate and one or both of iron nitrate or uranyl nitrate with ammonium hydroxide to form a mixture, and co-precipitating the mixture to produce the metal oxide. The mixture can have a pH of 8 to 9. The process can further include rinsing and drying the produced metal oxide. The produced metal oxide can then be calcined at a temperature of 400° C. to 600° C. for 4 to 10 hours or 4 to 8 hours, or 4 to 6 hours.

Another embodiment of the present invention includes a method for increasing oxygen mobility in cerium (Ce) oxide catalysts. The process can include doping or substituting a portion of Ce cations with iron cations or uranium cations or both. The Fe cations can be Fe (III) or Fe(II) or a combination thereof. The U cations can be U (IV), U (V), or U (VI), or a combination thereof.

In the context of the present invention embodiments 1 to 34 are disclosed. Embodiment 1 is a metal oxide capable of producing hydrogen from water or carbon monoxide from carbon dioxide that includes oxygen (O), cerium (Ce) and one or both of iron (Fe) and uranium (U). Embodiment 2 is the metal oxide of embodiment 1, wherein the metal oxide is a binary metal oxide. Embodiment 3 is the metal oxide of embodiment 2, wherein the binary metal oxide that includes Ce and Fe. Embodiment 4 is the metal oxide of embodiment 2, wherein the binary metal oxide includes Ce and U. Embodiment 5 is the metal oxide of embodiment 1, wherein the metal oxide is a ternary metal oxide. Embodiment 6 is the metal oxide of embodiment 1, wherein the ternary metal oxide includes Ce, Fe, and U. Embodiment 7 is the metal oxide of any one of embodiments 1 to 6, wherein Ce is Ce (IV). Embodiment 8 is the metal oxide of any one of embodiments 1 to 7, wherein Fe is Fe (III) or Fe(II) or a combination thereof. Embodiment 9 is the metal oxide of any one of embodiments 1 to 8, wherein U is U (IV), U (V), or U (VI), or a combination thereof. Embodiment 10 is the metal oxide of any one of embodiments 1 to 9, wherein the oxygen to metal ratio of the metal oxide is equal to or less than 2.5. Embodiment 11 is the metal oxide of any one of embodiments 1 to 10, having the following structure:

Ce_{w}FeₓU_{y}O_{z,}
where 0<w<1; where 0.1≦x<1−(w+y); where 0≦y<0.09; and where 1.5<z<2.5.
   Embodiment 12 is the metal oxide of any one of embodiments 1 to 11, wherein the metal oxide has a fluorite lattice structure. Embodiment 13 is the metal oxide of embodiment 12, wherein the metal oxide maintains its fluorite lattice structure when subjected to a temperature of 300 to 1400 K or 900 to 1400 K. Embodiment 14 is the metal oxide of any one of embodiments 1 to 13, wherein the metal oxide has been calcined at a temperature of 400 to 600° C. Embodiment 15 is the metal oxide of any one of embodiments 1 to 14, wherein the metal oxide has been reduced and contacted with water or carbon dioxide or a combination thereof. Embodiment 16 is the metal oxide of embodiment 15, wherein the metal oxide has been reduced with heat. Embodiment 17 is the metal oxide of any one of embodiments 1 to 16, wherein the metal oxide is capable of producing hydrogen from water or carbon monoxide from carbon dioxide with solar radiation as an energy source. Embodiment 18 is the metal oxide of any one of embodiments 1 to 17, further comprised within a composition.

Embodiment 19 is a water splitting system that includes the metal oxide of any one of embodiments 1 to 18, a heat source, and a water feed or a carbon dioxide feed or both. Embodiment 20 is the water splitting system of embodiment 19, wherein the heat source is sunlight. Embodiment 21 is the water splitting system of any one of embodiments 19 to 20, further including a collection device capable of storing H₂ or CO.

Embodiment 22 is a method for producing hydrogen gas from water or carbon monoxide from carbon dioxide. The method includes: (i) reducing the metal oxide of any one of embodiments 1 to 18 to form a reduced material; and (ii) contacting the reduced material with a feed that includes water under reaction conditions sufficient to produce hydrogen gas from the water or contacting the reduced material with a feed that includes carbon dioxide under reaction conditions sufficient to produce carbon monoxide from the carbon dioxide. Embodiment 23 is the method of embodiment 22, wherein the feed that includes water and wherein hydrogen gas is produced from the water. Embodiment 24 is the method of embodiment 23, wherein the water is in a gaseous or vapor phase. Embodiment 25 is the method of embodiment 22, wherein the feed that includes carbon dioxide and wherein carbon monoxide is produced from the carbon dioxide. Embodiment 26 is the method of embodiment 22, wherein the feed that includes water and carbon dioxide and wherein hydrogen gas is produced from the water and carbon monoxide is produced from the carbon dioxide. Embodiment 27 is the method of any one of embodiments 22 to 26, wherein step (i) is performed at a temperature of 1000 to 1500° C. Embodiment 28 is the method of embodiment 27, wherein step (ii) is performed at a temperature of 1000 to 1500° C. Embodiment 29 is the method of any one of embodiments 22 to 28, further including isolating the produced hydrogen gas or the produced carbon monoxide.

Embodiment 30 is a method for making a metal oxide of any one of embodiments 1 to 18. The method includes mixing cerium nitrate and one or both of iron nitrate or uranyl nitrate with ammonium hydroxide to form a mixture, and co-precipitating the mixture to produce the metal oxide. Embodiment 31 is the method of embodiment 30, wherein the mixture has a pH of 8 to 9. Embodiment 32 is the method of any one of embodiments 30 or 31, further including rinsing and drying the produced metal oxide. Embodiment 33 is the method of any one of embodiments 30 to 32, further including calcining the produced metal oxide at a temperature of 400° C. to 600° C. for 4 to 10 hours or 4 to 8 hours, or 4 to 6 hours.

Embodiment 34 is a method for increasing oxygen mobility in cerium (Ce) oxide catalysts that are capable of producing hydrogen from water or carbon monoxide from carbon dioxide, the method comprising substituting a portion of Ce cations with iron (Fe) cations or uranium (U) cations or both.

The following includes definitions of various terms and phrases used throughout this specification.

“Water splitting” or any variation of this phrase describes the chemical reaction in which water is separated into oxygen and hydrogen.

“Binary metal oxide” refers to a metal oxide comprising two different metals.

“Ternary metal oxide” refers to a metal oxide comprising three different metals.

Ce (IV), Ce (III), Fe (III), Fe (II), U (IV), U (V), and U (VI) refer to the oxidation states of Ce, Fe, and U. In particular, the Roman numeral refers to the oxidation state.

The terms “about” or “approximately” are defined as being close to as understood by one of ordinary skill in the art, and in one non-limiting embodiment the terms are defined to be within 10%, preferably within 5%, more preferably within 1%, and most preferably within 0.5%.

The use of the word “a” or “an” when used in conjunction with the term “comprising” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The metal oxides of the present invention can “comprise,” “consist essentially of,” or “consist of” particular components, compositions, ingredients, etc. disclosed throughout the specification. With respect to the transitional phase “consisting essentially of,” in one non-limiting aspect, a basic and novel characteristic of the metal oxides of the present invention are their increased O²⁻ mobility as well as stabilization of the fluorite structure when subjected to a reducing reaction.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

FIG. 1: Illustration of the fluorite structure of CeO₂. Ce (IV) cations are at the center of a cube. Every other cube does not contain Ce (IV) to maintain the CeO₂ stoichiometry.

FIG. 2: Illustration of various products that can be produced from syngas.

FIG. 3: In situ X-Ray Diffraction (XRD) of as prepared Ce_{0.5}U_{0.5}O₂ at room temperature and then heated at the indicated temperatures.

FIG. 4: In situ X-Ray Diffraction (XRD) of as prepared Ce_{0.75}Fe_{0.25}O₂ at room temperature and then heated at the indicated temperatures.

FIG. 5A: X-ray Photoelectron Spectroscopy (XPS) of Fe2p region for Ce_{0.75}Fe_{0.25}O₂, as a function of reduction time (by Ar⁺ sputtering).

FIG. 5B: X-ray Photoelectron Spectroscopy (XPS) of Fe2p region for Ce_{0.95}Fe_{0.05}O₂, as a function of reduction time (by Ar⁺ sputtering).

FIG. 6A: Thermal Gravimetric Analysis (TGA) of CeO₂.

FIG. 6B: Thermal Gravimetric Analysis (TGA) of Ce_{0.75}Fe_{0.25}O₂.

### DETAILED DESCRIPTION OF THE INVENTION

The currently available materials that are used to produce hydrogen or carbon monoxide gas from water or carbon dioxide, respectively, require a high activation energy. In particular, and as illustrated above in equation 1, the reduction step of metal oxide catalysts requires heat input.

The present invention relates to doped or modified cerium dioxide catalysts that decrease the temperature/heat input needed for the reduction step to occur. Without wishing to be bound by theory, this reduced energy input is believed to be due to the introduction of Fe or U cations or both into the cerium oxide lattice structure. The Fe and U cations act to (1) reduced the energy needed to remove the lattice oxygen anions, O²⁻, (2) enhance O²⁻ mobility and (3) stabilize the fluorite structure when the catalysts of the present invention are subjected to a reducing reaction.

These and other non-limiting aspects of the present invention are discussed in further detail in the following sections.

### A. Cerium-Based Oxides

The cerium-based oxides of the present invention includes oxygen (O), cerium (Ce) and one or both of iron (Fe) and uranium (U). The cerium-based oxides are capable of producing hydrogen from water and carbon monoxide from carbon dioxide. In one embodiment, the metal oxide comprises Ce (IV) and one or both of Fe cations (e.g., Fe (II) or Fe (III) or both) and uranium cations (e.g., U (IV), U (V), or U (VI)) or any combination or all of said cations. The cerium-based oxides of the present invention are capable of being activated via a reduction reaction. In this context, the term “activated” refers to a change in the material to a state in which the metal oxide optimally performs its desired function. In particular, Ce (IV) in the fluorite lattice structure is activated/reduced to Ce (III); in the case of Fe doped ceria, Fe can also exist in its metallic form (Fe⁰) in the reduced material. Once activated, the Ce (III) can then be oxidized via oxygen from water, leaving behind the desired H₂ gas or via oxygen from carbon dioxide, leaving behind the desired carbon monoxide gas.

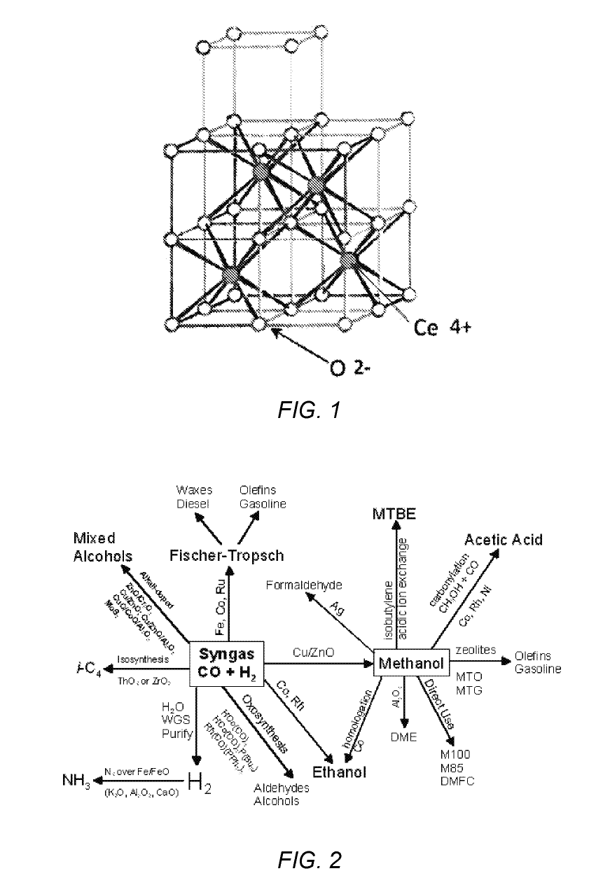

As illustrated in FIG. 1, cerium dioxide (also referred to as cerium (IV) oxide, ceria, ceric oxide) has a fluorite lattice structure and a chemical formula of CeO₂. In one non-limiting embodiment of the present invention, cerium dioxide is commercially available in nano-powder and powdered forms from Sigma-Aldrich®, St. Louis, Mo. (USA). The cerium dioxide can be modified or doped with Fe cations via iron (II) oxide (i.e., FeO) or iron (III) oxide (i.e., Fe₂O₃). Both iron (II) oxide and iron (III) oxide are commercially available in nano-powder and powdered forms from Sigma-Aldrich®, St. Louis, Mo. (USA). In preferred embodiments, iron (III) oxide is used. The cerium dioxide can also be doped or modified with uranium cations via uranium (IV) oxide (i.e., UO₂) or uranium (VI) oxide (i.e., UO₃). Both uranium (IV) oxide and uranium (VI) oxide are commercially available in nano-powder and powdered forms from Sigma-Aldrich®, St. Louis, Mo. (USA). In preferred embodiments, uranium (IV) oxide is used.

A general stoichiometric structure of the cerium-based oxides of the present invention includes the following:

Ce_{w}FeₓU_{y}O_{z},

where 0<w<1, where 0.1≦x<(1−(w+y), where 0≦y<0.09, and where 1.5<z<2.5. However, and in preferred embodiments, z is 1.5<z<2, or more preferably 2. The following Table 1 provides some non-limiting examples of the various amounts of w, x, and y that can be used with the catalysts of the present invention:

TABLE 1

| w | x | y | sum |
|---|---|---|---|
| 0 | 1 | 0 | 1 |
| 0.1 | 0.89 | 0.01 | 1 |
| 0.2 | 0.78 | 0.02 | 1 |
| 0.3 | 0.67 | 0.03 | 1 |
| 0.4 | 0.56 | 0.04 | 1 |
| 0.5 | 0.45 | 0.05 | 1 |
| 0.6 | 0.34 | 0.06 | 1 |
| 0.7 | 0.23 | 0.07 | 1 |
| 0.8 | 0.12 | 0.08 | 1 |
| 0.9 | 0.01 | 0.09 | 1 |
| 1 | 0 | 0 | 1 |

Generally, preparation of the cerium-based catalysts of the present invention involves the steps of preparing a primary solid, processing the primary solid, for example by heat treatment, to obtain a metal oxide precursor, and activation of the precursor to give the activated metal oxide. The heat treatment of the metal oxide solids or precursors may include steps of drying, thermal decomposition of salts, and/or calcination. The term “calcination” refers to a heat treatment of a material in an oxidizing atmosphere for a certain period of time.”

In particular, the initial preparation of the primary solid can be performed by a variety of methods known in the art. By way of example only, such methods can include co-precipitation from a solution of salts of the desired products, flame spray synthesis, and flame spray pyrolysis. In one particular embodiment, the cerium-based oxides are prepared by co-precipitation from their nitrate salts. In a further embodiment, the metal oxides are precipitated at a pH of 8-9. In certain instances, the precipitation agent used in the preparation of the metal oxides is ammonium hydroxide (NH₄OH). The co-precipitation steps generally conform to the following parameters: Metal oxide materials were synthesized by the precipitation method. For example Ce0.5U0.5O₂ can be prepared as follows. An aqueous solution of cerium (III) nitrate hexahydrate (Fluka) and zirconyl chloride octahydrate (Fluka) can be prepared with 50 mol % Ce⁴⁺ and 50 mol % U⁴⁺ cations. Then, ammonium hydroxide can be added until the pH of the solution is about 9 where cerium and uranium hydroxides have co-precipitated. The precipitate can be washed with distilled water until neutral pH then dried over night at 100° C. followed by calcination at 500° C. in air for 5 hours. The same method can be used to prepare all of the catalysts of the present invention. Following co-precipitation, the single or mixed hydroxides may undergo a series of washing and drying steps. The material may be heated in a dry inert atmosphere at sufficiently high temperature to remove substantially all activity-affecting amounts of water and carbon dioxide. In certain instances, the washing steps are undergone at a neutral pH with water. The drying step may comprise drying the material in a heated environment (e.g. 100° C.). The drying step may comprise drying the material for at least 6, at least 8, at least 10, at least 12, or at least 14 hours. In some embodiments, the material may be dried for 6-18 hours, 8-15 hours, or 10-15 hours. The drying step may be done in a heated environment of at least 100° C., or at least 200, 300, or 400° C.

Following precipitation and drying, the material may be calcined to make the oxides. The calcination step may be performed at a temperature of 500° C. until the desired product is formed. In some instances, the materials are calcined for five hours. In further instances, the materials may be calcined for 6, 7, 8, 9, or more hours. In one embodiment, calcination of the materials takes place at a temperature that is higher than that of the metal oxide operating temperature. In certain embodiments, calcination takes place at a temperature of 400, 500, 600, 700, 800, 900 or 1000° C. In further embodiments, calcination takes place at a temperature of 300-1000° C., 400-1000° C., 400-900° C., 400-800° C., 400-700° C., or 400-600° C.

After calcination, the metal oxides may be activated. Activation of the material may include reduction of the metal oxide. Activation may be performed, for example, with hydrogen gas. In another instance, activation may be performed with an inert gas. Inert gases include, for example, nitrogen, helium, neon, argon, krypton, xenon, and radon gases. In some embodiments, activation of the metal oxide is performed under inert atmosphere. In further embodiments, activation of the metal oxide is performed in a vacuum. When activation is performed in a vacuum, the pressure may be 0.01 torr. In further embodiments, the pressure in the vacuum may be 0.005, 0.02, 0.03, or 0.05 torr. The metal oxides described herein are particularly useful since they may be activated at a lower temperature. In certain embodiments, the metal oxides are activated at temperature of 100-1000° C., 100-900° C., 100-800° C., 200-800° C., 200-700° C., 300-700° C., 300-600° C., 300-500° C., 300-400° C., or 100-500° C., 100-400° C., 100-300° C., or 100-200° C. In particular instances, the activation can take place at about 500° C. or above in the presence of hydrogen, at about 700° C. or above in the presence of methane, and about 1300° C. and above in the presence of an inert environment (e.g., N₂, He, or Ar, or any combination thereof).

### B. Methods for Producing Syngas

Aspects of the disclosure relate to methods for producing syngas (i.e. hydrogen and carbon monoxide). The metal oxides described herein may be in contact with water and capable of producing hydrogen gas from the water. In another instance, the metal oxide may be in contact with carbon dioxide and be capable of producing carbon monoxide from the carbon dioxide. In a further embodiment, the metal oxide is in contact with water and carbon dioxide and is capable of producing hydrogen gas and carbon monoxide from the water and the carbon dioxide. In certain embodiments, the metal oxide is capable of producing hydrogen from water or carbon monoxide from carbon dioxide with solar radiation as the energy source.

Further aspects of the disclosure relate to a metal oxide in a water-splitting system. The water-splitting system may comprise a composition comprising a metal oxide described herein and water or carbon dioxide or both. In one embodiment, there is a water splitting system and a heat source. In a further embodiment, the heat source is sunlight. The heat source may also be produced mechanically or electrically by, for example, an oven, a microwave, a heat gun, an electric high temperature furnace, or other common laboratory source of heat.

Methods of the disclosure include a method for producing hydrogen gas from water, the method comprising contacting the metal described herein with water under reaction conditions sufficient to produce hydrogen gas from the water and the metal oxide. A further method relates to a method for producing carbon monoxide from carbon dioxide, the method comprising contacting a metal oxide of the disclosure with carbon dioxide under reaction conditions sufficient to produce carbon monoxide from the carbon dioxide and the metal oxide. In certain instances, the methods are conducted in a reactor. The reactor may be, for example, a tank, a pipe, or a tubular reactor. The reactor may be used as a continuous reactor or a batch reactor and may accommodate one or more solids, fluids, or gases (e.g. reagents, catalysts, or inert materials). The reactors may run at a steady-state or operated in a transient state. When a reactor is first brought into operation (after maintenance or in operation) it would be considered to be in a transient state, where key process variable change with time. The process variables may be estimated according to models such as batch reactor model, continuous stirred-tank reactor model, or plug flow reactor model. Key process variables may include, for example, residence time, volume, temperature, pressure, concentration of chemical species, and heat transfer coefficients. The reactor may be a packed bed in which the packing inside the bed comprises the metal oxide. The chemical reactor may also be a fluidized bed. The chemical reactions in the reactor may be exothermic or endothermic. In certain instances, the activated metal catalyst is used in the methods described herein. In further instances, the method comprises the catalyst in a non-activated state, and the activation of the catalyst occurs just before the reaction with water or carbon dioxide. In certain instances, the activation of the catalyst may be done in the reactor. In further instances, the catalyst is activated prior to reactor loading.

In the methods described herein, the water may be in a liquid, gaseous, or vapor phase. In one embodiment, the water is in a gaseous or vapor phase. In one non-limiting instance, the carbon dioxide can be obtained from a waste or recycle gas stream (e.g. from a plant on the same site, like for example from ammonia synthesis) or after recovering the carbon dioxide from a gas stream. A benefit of recycling such carbon dioxide as starting material in the process of the invention is that it can reduce the amount of carbon dioxide emitted to the atmosphere (e.g., from a chemical production site). In a further embodiment, the carbon dioxide is from a feed stream comprising carbon dioxide and water, and wherein hydrogen gas is produced from the water and the metal oxide. The chemical reaction may be carried out such that the reduction step under inert conditions is typically about 350° C. to 450° C. (or more preferably about 400° C.) above that of the reaction step (contact with water). Therefore, and by way of example, a reduction at about 1400° C. can be followed by a reaction at about 1000° C. The reduction step under a reducing environment (e.g., such as with a hydrocarbon) can be done at the same temperature as with an inert environment.

In some embodiments, the methods described herein may further comprise isolating the produced hydrogen or the produced carbon monoxide.

The resulting syngas can then be used in additional downstream reaction schemes to create additional products. FIG. 2 is an illustration of various products that can be produced from syngas. Such examples include chemical products such as methanol production, olefin synthesis (e.g. via Fischer-Tropsch reaction), aromatics production, carbonylation of methanol, carbonylation of olefins, the reduction of iron oxide in steel production, etc.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

Preparation of metal oxides. CeO₂, Fe₂O₃, Ce(Fe)O₂₋ₓ, and Ce(Fe,U)O₂₋ₓ (where x is less than 0.5) were prepared by the co-precipitation method from their nitrate salts at pH 8-9. Ammonium hydroxide was used as a precipitating agent. The single or mixed hydroxides were washed with de-ionized water until neutral pH, dried overnight at 100° C. then calcined to make the oxides at 500° C. for five hours or more. X-ray diffraction, temperature programmed reduction, BET surface area, and X-ray photoelectron spectroscopy were conducted to further identify and study the materials.

Activation and reaction of metal oxides. Reactions were conducted in a tubular reactor capable of working up to 1600° C. Prior to reactions, catalysts were either reduced with hydrogen or under inert atmosphere using N₂ gas or vacuum (ca. 10⁻² torr). After the reduction step, the material was exposed to steam using N₂ as a carrier gas and hydrogen was monitored using a GC equipped with a thermal conductivity detector (TCD).

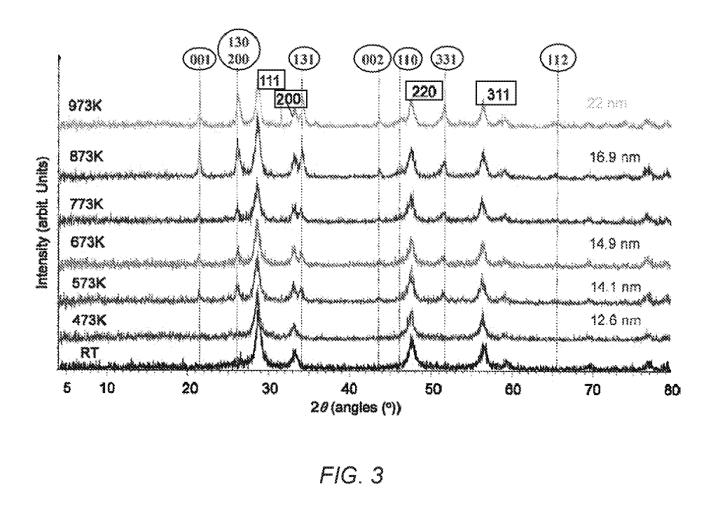

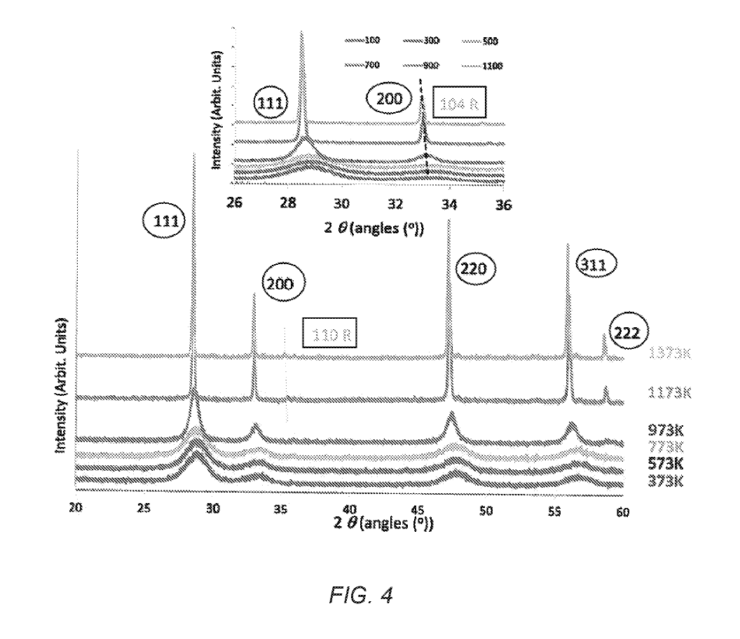

FIG. 3 presents XRD of as prepared Ce_{0.5}U_{0.5}O₂ that has been heated to the indicated temperatures while FIG. 4 presents similar results for Ce_{0.75}Fe_{0.25}O₂. The numbers at the right hand side of the figure are those of crystallites size based on the 111 diffraction line of the fluorite structure at 2θ=28.54 (d=3.12 Å). The numbers encompassed by a circle on top of the dashed vertical lines in the figure are the diffraction pattern of α-U₃O₈. The numbers encompassed by a box on top of the dashed vertical lines are the diffraction pattern of the fluorite solid solution. In both cases the fluorite structure is maintained for the as prepared materials as well as after high temperature treatment, although the presence of U₃O₈ (FIG. 3, above 800 K) and Fe₂O₃ (FIG. 4, above 1000 K) could be observed. FIG. 4 is an in situ X-Ray Diffraction (XRD) of as prepared Ce_{0.75}Fe_{0.25}O₂ at room temperature and then heated at the indicated temperatures. The numbers encompassed by a circle are those of the diffraction pattern of CeO₂. The numbers encompassed by a box are those of Fe₂O₃. The inset is an expansion of the 2θ x-axis for the (111) and (200) lines.

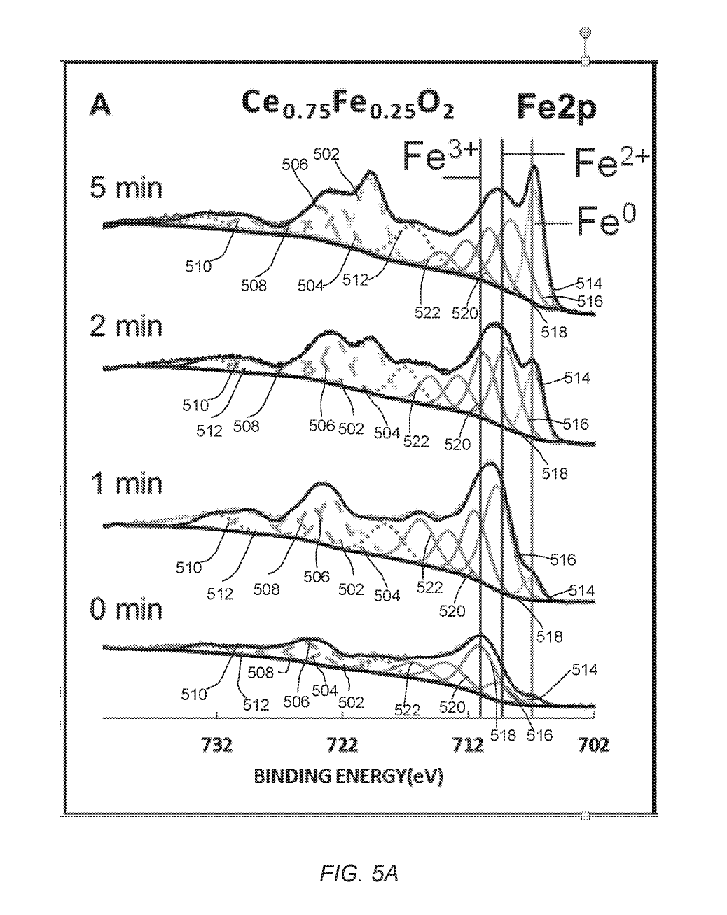

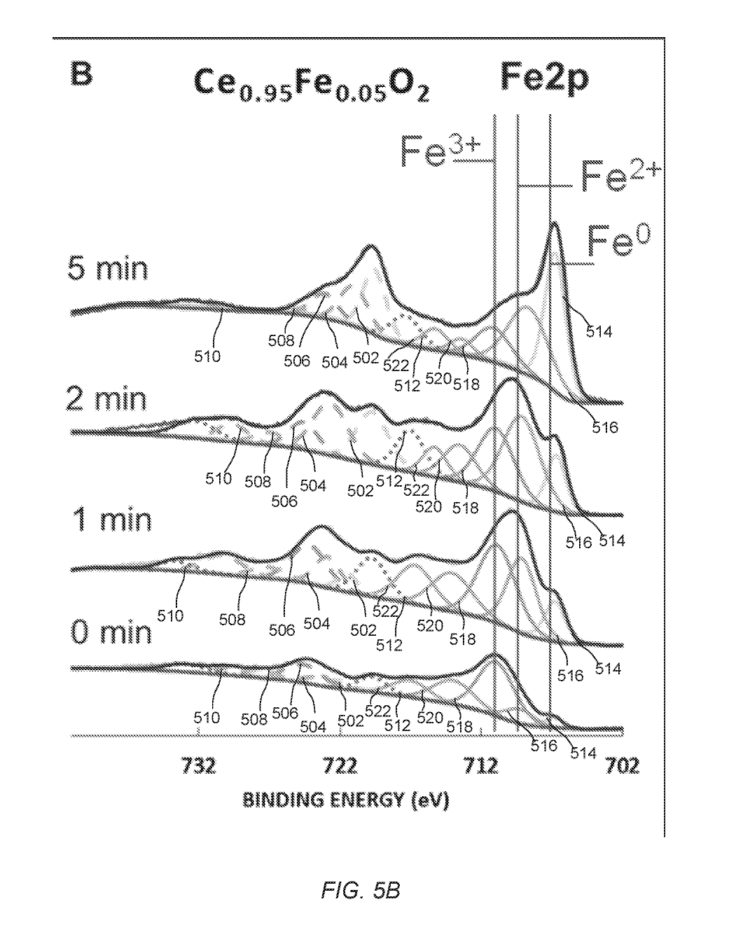

FIG. 5A presents an X-ray Photoelectron Spectroscopy (XPS) of Fe2p region for Ce_{0.75}Fe_{0.25}O₂ as a function of reduction time (by Ar⁺ sputtering). FIG. 5B presents an X-ray Photoelectron Spectroscopy (XPS) of Fe2p region for Ce_{0.95}Fe_{0.05}O₂ as a function of reduction time (by Ar⁺ sputtering). The XPS fitted peaks are: line 502 is Fe⁰2p_{3/2}, line 504 is Fe²⁺2p_{3/2}, line 506 is Fe³⁺2p_{3/2}, line 508 is Fe²⁺2p_{3/2} satellite, line 510-Fe³⁺2p_{3/2} satellite, line 512 is Ce Mn1 and CE Mn2; line 514 is Fe⁰2p_{3/2}, line 516 is Fe²⁺2p_{1/2}, line 518 is Fe³⁺2p_{1/2}, line 520 is F²⁺2p_{1/2} satellite, line 522 is Fe³⁺2p_{1/2} satellite. The behavior of Fe reduction as a function of sputtering follows a consecutive reduction Fe³⁺→Fe²⁺→Fe⁰. In this sequence, Fe³⁺ decreases upon reduction to Fe²⁺ which in turn is further reduced to Fe⁰.

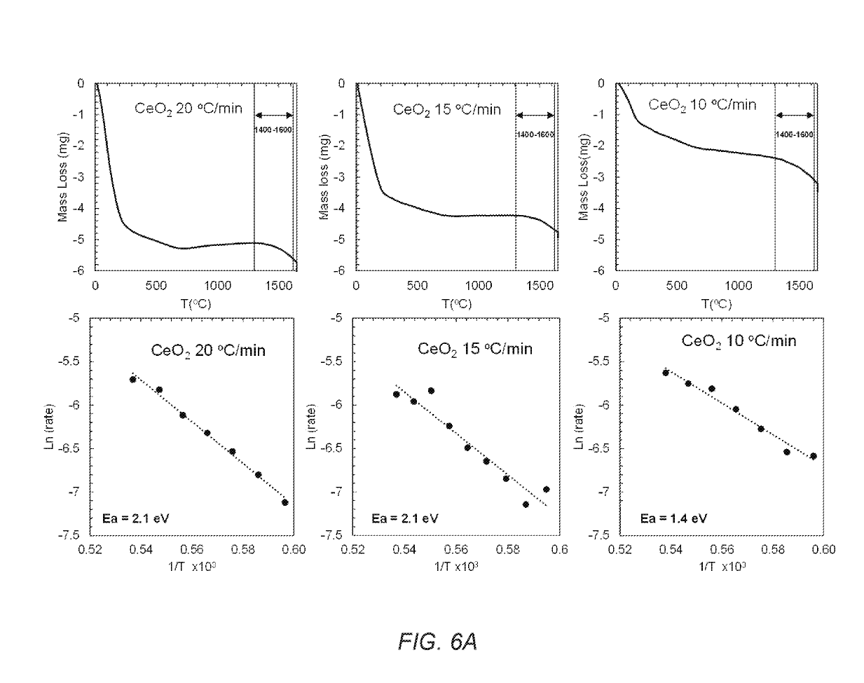

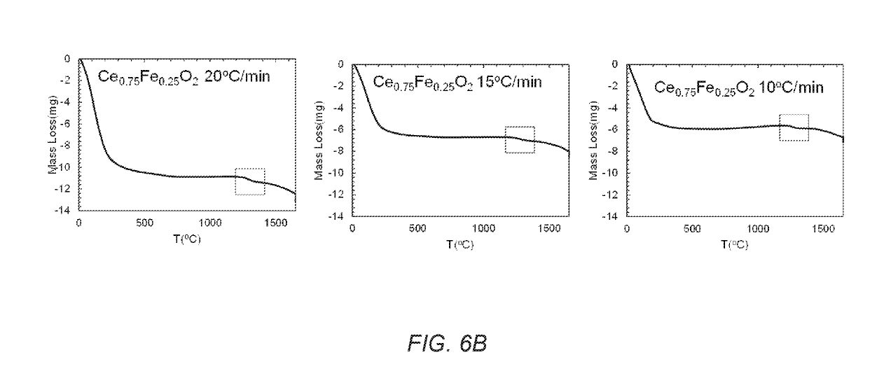

FIG. 6A is a thermal Gravimetric Analysis (TGA) of CeO₂. (Top) TGA profile of CeO₂ at different heating rates (10, 15 and 20° C.) which exhibit four regions: (i) the first one was between 100-200° C. due to the loss of water; (ii) the second region was between 300-700° C. due to the loss of carboxylates and carbonates; (iii) the third was a flat region between 800-1100° C.; and (iv) the fourth region, the most important one, was between 1400-1600° C. due to the reduction of CeO₂ (loss of O₂). Kinetics of the reduction of CeO₂ was also extracted from TGA (bottom) by plotting In (rate) vs 1/T, where the rate is dm/dT. dm was the change in mass; dT was the change in temperature. Moreover, the activation energy (Eₐ) was calculated (values on the plot) from the slope of the plot. Within the investigated heating rate it appeared that the activation energy of 2.1 eV could be extracted. The fact that Eₐ did not increase between 15° C./min and 20° C./min may indicate that extraction of oxygen anions from the lattice is not kinetically limited. In other words, there was enough residence time to remove oxygen anions during heating. FIG. 6 B is a thermal Gravimetric Analysis (TGA) of Ce_{0.75}Fe_{0.25}O₂. The TGA profile of Ce—Fe material at different heating rates (10, 15 and 20° C.), and was similar to that of CeO₂, however, there was one more region appearing between 1100-1300° C. (in boxed on the figure), which was due to the reduction of Fe³⁺ cations in Fe₂O₃. The more pronounced response to the heating rate in this region may indicate that the rate at which this mass loss occurs was higher as the heating rate was increased.

1. A metal oxide capable of producing hydrogen from water or carbon monoxide from carbon dioxide comprising oxygen (O), cerium (Ce) and one or both of iron (Fe) and uranium (U).

2. The metal oxide of claim 1, having the following structure:
Ce_{w}FeₓU_{y}O_{z,}
where 0<w<1;
where 0.1≦x<1−(w+y);
where 0≦y<0.09; and
where 1.5<z<2.5.

3. The metal oxide of claim 2, wherein the metal oxide has a fluorite lattice structure.

4. The metal oxide of claim 3, wherein the metal oxide maintains its fluorite lattice structure when subjected to a temperature of 300 to 1400 K or 900 to 1400 K.

5. The metal oxide of claim 2, wherein the metal oxide is a binary metal oxide.

6. The metal oxide of claim 5, wherein the binary metal oxide comprises Ce and Fe.

7. The metal oxide of claim 5, wherein the binary metal oxide comprises Ce and U.

8. The metal oxide of claim 2, wherein the metal oxide is a ternary metal oxide.

9. The metal oxide of claim 2, wherein Ce is Ce (IV), Fe is Fe (III) or Fe(II) or a combination thereof, and U is U (IV), U (V), or U (VI), or a combination thereof.

10. The metal oxide of claim 1, wherein the oxygen to metal ratio of the metal oxide is equal to or less than 2.5.

11. The metal oxide of claim 1, wherein the metal oxide has been calcined at a temperature of 400 to 600° C.

12. The metal oxide of claim 1, wherein the metal oxide has been reduced and contacted with water or carbon dioxide or a combination thereof.

13. The metal oxide of claim 12, wherein the metal oxide has been reduced with heat.

14. The metal oxide of claim 1, wherein the metal oxide is capable of producing hydrogen from water or carbon monoxide from carbon dioxide with solar radiation as an energy source.

15. A water splitting system comprising the metal oxide of claim 1, a heat source, and a water feed or a carbon dioxide feed or both.

16. A method for producing hydrogen gas from water or carbon monoxide from carbon dioxide, the method comprising:
(i) reducing the metal oxide of claim 1 to form a reduced material; and
(ii) contacting the reduced material with a feed comprising water under reaction conditions sufficient to produce hydrogen gas from the water or contacting the reduced material with a feed comprising carbon dioxide under reaction conditions sufficient to produce carbon monoxide from the carbon dioxide.

17. The method of claim 16, wherein the feed comprises water and wherein hydrogen gas is produced from the water.

18. The method of claim 17, wherein the water is in a gaseous or vapor phase.

19. The method of claim 16, wherein the feed comprises carbon dioxide and wherein carbon monoxide is produced from the carbon dioxide.

20. The method of claim 19, wherein the feed comprises water and carbon dioxide and wherein hydrogen gas is produced from the water and carbon monoxide is produced from the carbon dioxide.

21. A method for making a metal oxide of claim 1, the method comprising mixing cerium nitrate and one or both of iron nitrate or uranyl nitrate with ammonium hydroxide to form a mixture, and co-precipitating the mixture to produce the metal oxide.

22. A method for increasing oxygen mobility in cerium (Ce) oxide catalysts that are capable of producing hydrogen from water or carbon monoxide from carbon dioxide, the method comprising substituting a portion of Ce cations with iron (Fe) cations or uranium (U) cations or both.
